(19) United States
(12) Patent Application Publication
(10) Pub. No.: US 2018/0328239 A1
(43) Pub. Date: Nov. 15, 2018

(54) INTERNAL-COMBUSTION ENGINE VALVE TIMING CONTROL DEVICE

(71) Applicant: HITACHI AUTOMOTIVE SYSTEMS, LTD., Hitachinaka-shi, Ibaraki (JP)

(72) Inventors: Ryo TADOKORO, Hadano-shi, Kanagawa (JP); Isao DOI, Isehara-shi, Kanagawa (JP); Hiroyuki NEMOTO, Hitachi-shi, Ibaraki (JP); Seiichi SUE, Atsugi-shi, Kanagawa (JP)

(73) Assignee: HITACHI AUTOMOTIVE SYSTEMS, LTD., Hitachinaka-shi, Ibaraki (JP)

(21) Appl. No.: 15/534,160

(22) PCT Filed: Nov. 27, 2015
(86) PCT No.: PCT/JP2015/083384

§ 371 Date: Jun. 8, 2017

(30) Foreign Application Priority Data
Dec. 12, 2014 (JP) 2014-251520

(51) Int. Cl. F01L 1/352; H02K 5/10; F01L 1/344; F16C 19/54

(52) U.S. Cl. CPC F01L 1/352; H02K 5/10; F01L 2820/032; F16C 19/541; F01L 2250/02; F01L 1/34403

(57) ABSTRACT

A communicating hole, which communicates between a clearance space and the outside of a cover member, is formed in the cover member, and a seal cap is fitted to and retained in a distal-end opening of the communicating hole. The seal cap includes a cap main body having a ventilation through hole formed in an internal axial direction and an outer peripheral wall configured to engage with the communicating hole, a supporting portion fitted, from the outside, into a recessed groove formed in an outside end face of the cap main body, and a ventilation filter located on a bottom face of the recessed groove and retained and sandwiched between the cap main body and the supporting portion. Therefore, an internal pressure rise in the clearance space between the cover member and an electric motor can be effectively suppressed, and thus improved mountability and retainability can be obtained.

### TECHNICAL FIELD

The present invention relates to an internal-combustion engine valve timing control device configured to control valve open timing and valve closure timing of intake valves and/or exhaust valves.

### BACKGROUND ART

One such internal-combustion engine valve timing control device has been disclosed in the following prior-art Patent document 1, previously filed by the same applicant as the present invention.

In the valve timing control device disclosed in the Patent document 1, a cover member is provided at the front end side of a motor housing of an electric motor with a prescribed clearance space. Also provided or held on the cover member are a pair of electricity-feeding brushes whose top ends face the clearance space. On the other hand, a pair of electricity-feeding slip rings are installed on an electricity-feeding plate, which is located onto the front end section of the motor housing. The previously-discussed electricity-feeding brushes are kept in sliding-contact with the respective slip rings for electricity-feeding to coils of the electric motor.

A seal cap is press-fitted into a work hole (a through hole), which is formed to penetrate through a substantially center of the cover member, in a fluid-tight fashion, for preventing water, dust and/or debris from entering the clearance space between the cover member and the motor housing from the outside.

Electric current, which is supplied from a battery power source, is applied to the slip rings via the electricity-feeding brushes in sliding-contact with the respective slip rings. Also, when varying valve timing, the electric motor is energized through the use of switching brushes and a commutator, such that a rotational force (torque) of the electric motor is transmitted through a speed reducer to a camshaft and thus a relative rotational phase of the camshaft to a timing sprocket is converted, thereby controlling valve open timing and valve closure timing of intake valves and/or exhaust valves.

However, in the valve timing control device disclosed in the aforementioned Patent document 1, the previously-discussed clearance space is sealed in an airtight fashion (in a fluid-tight fashion) by means of the seal cap and a seal member installed between the outer peripheral surface of the motor housing and the inner peripheral surface of an outer circumferential part of the cover member.

For that reason, owing to a temperature rise in the clearance space, caused by frictional heat generated during sliding motion between the electricity-feeding brushes and the respective slip rings, the internal pressure in the clearance space tends to rise. Therefore, there is a possibility that component parts, including the seal cap, the seal member and the like, are undesirably deformed, and thus these component parts accidentally come off.

### CITATION LIST

### Patent Literature

Patent document 1: JP2013-167181 A

### SUMMARY OF INVENTION

It is, therefore, in view of the previously-described drawbacks of the prior art, an object of the invention to provide an internal-combustion engine valve timing control device provided with a seal cap having a ventilation filter, thereby enabling the improved mountability and retainability, while effectively suppressing a rise of internal pressure in a clearance space by means of the ventilation filter.

In order to accomplish the aforementioned and other objects, according to the present invention as recited in claim 1 of the claimed invention, especially, an internal-combustion engine valve timing control device includes a cover member provided to cover at least a part of the electric motor, slip rings provided at one of the electric motor and the cover member, electricity-feeding brushes provided at the other of the electric motor and the cover member and having top ends kept in sliding-contact with the respective slip rings for electricity-feeding to the electric motor, a clearance space defined between the electric motor and the cover member and configured such that sliding-contact parts of the slip rings with the electricity-feeding brushes face onto the clearance space, a communicating hole formed in the cover member for communicating between the clearance space and an outside of the cover member, and a ventilation plug press-fitted into the communicating hole from the outside of the cover member, wherein the ventilation plug comprises a plug main body having a ventilation hole formed to penetrate through the plug main body in an axial direction and an outer circumferential part configured to be fitted to and retained in an outer opening edge of the communicating hole, a fitting portion fitted into a recessed groove formed in an outside end face of the plug main body, and a ventilation filter located on a bottom face of the recessed groove, onto which the ventilation hole faces, and retained and sandwiched between the plug main body and the fitting portion.

According to the present invention, it is possible to enable the improved mountability and retainability without letting the fitting portion come off, while effectively suppressing a rise of internal pressure in the clearance space by means of the ventilation plug.

### BRIEF DESCRIPTION OF DRAWINGS

FIG. 1 is a longitudinal cross-sectional view illustrating an embodiment of a valve timing control device according to the invention.

FIG. 2 is a disassembled perspective view illustrating the essential component parts of the embodiment.

FIG. 3 is a cross-sectional view taken along the line A-A of FIG. 1.

FIG. 4 is a cross-sectional view taken along the line B-B of FIG. 1.

FIG. 5 is a back view of an electricity-feeding plate of the embodiment.

FIG. 6 is a perspective view of a cover member of the embodiment.

FIG. 7 is an enlarged view of a cross-section marked with an area “C” in FIG. 1.

FIG. 8 is a front view of a seal cap of the embodiment.

FIG. 9 is a back view of the seal cap.

### DESCRIPTION OF EMBODIMENTS

An embodiment of an internal-combustion engine valve timing control device according to the invention is hereinafter described in detail with reference to the drawings. In the shown embodiment, the variable valve timing control device is applied to an intake-valve side.

### First Embodiment

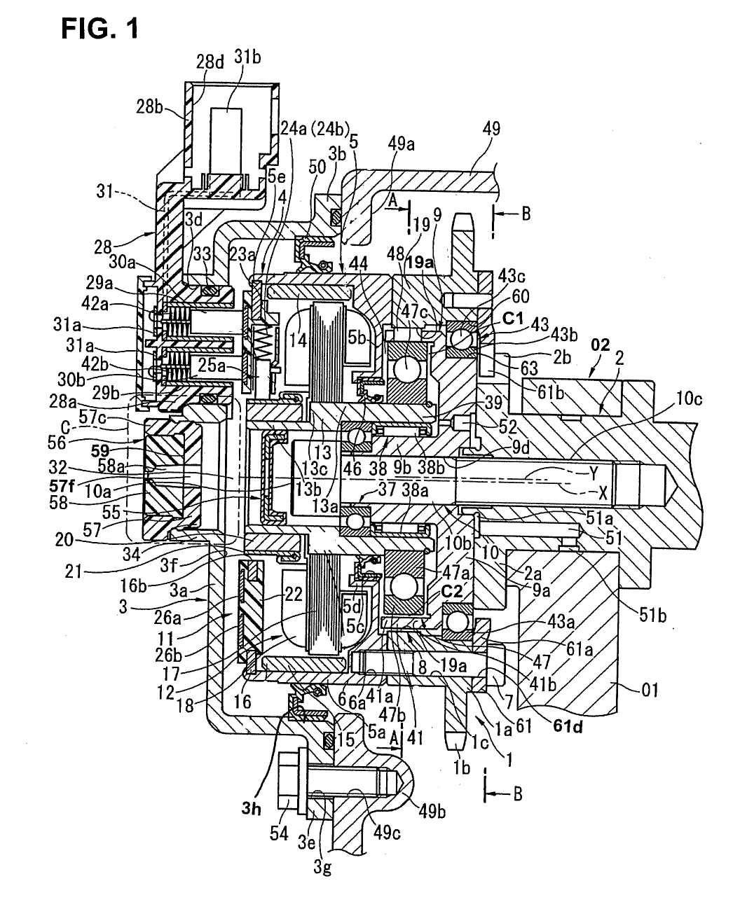

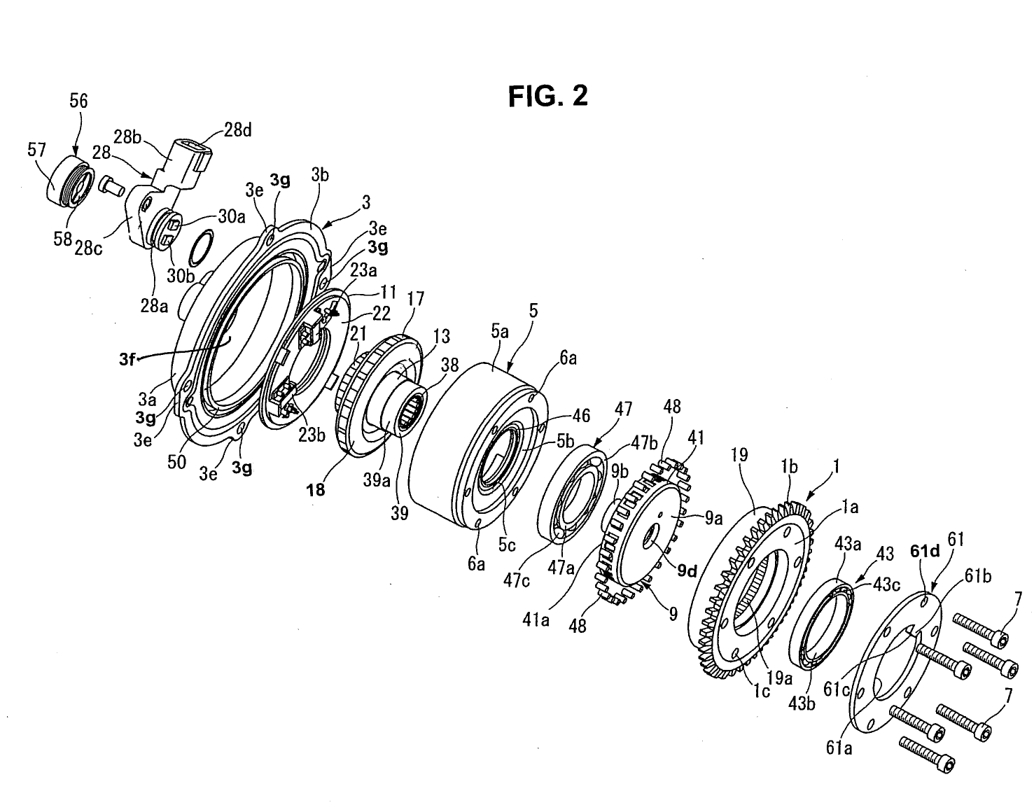

As shown in FIGS. 1-2, the valve timing control device of the embodiment is equipped with a timing sprocket 1 serving as a driving rotational member rotationally driven by a crankshaft of an internal combustion engine, a camshaft 2 rotatably supported on a cylinder head 01 via a journal bearing 02 and rotated by a rotational force transmitted from the timing sprocket 1, a cover member 3 fixedly connected to a chain cover 49 arranged in front of timing sprocket 1, and a phase conversion mechanism 4 interposed between the timing sprocket 1-and the camshaft 2 for converting or varying a relative rotational phase of the camshaft 2 to the timing sprocket 1 depending on an engine operating condition.

Timing sprocket 1 is integrally formed into a substantially annular shape and made from iron-based metal material. The timing sprocket is comprised of a sprocket body 1a formed with a stepped inner peripheral portion, a gear 1b formed integral with the outer periphery of sprocket body 1a and configured to receive a rotational force from the crankshaft through a wrapped timing chain (not shown), and an internal-tooth structural portion 19 integrally formed on the front end side of sprocket body 1a.

Also, timing sprocket 1 is rotatably supported by a large-diameter ball bearing 43 interleaved between the sprocket body 1a and a driven member 9 (described later) fixedly connected to the front end section of camshaft 2, so as to permit rotary motion of camshaft 2 relative to timing sprocket 1.

Large-diameter ball bearing 43 is comprised of an outer ring 43a, an inner ring 43b, and balls 43c confined between outer and inner rings 43a, 43b. The outer ring 43a is fixed to the inner periphery of sprocket body 1a, whereas the inner ring 43b is press-fitted and fixed to the outer periphery of driven member 9.

Sprocket body 1a has an annularly-grooved outer-ring retaining portion 60 formed and cut in its inner peripheral surface and configured to open toward the camshaft 2.

Outer-ring retaining portion 60 is formed as a shouldered annular groove into which the outer ring 43a of large-diameter ball bearing 43 is axially press-fitted. The shouldered portion of outer-ring retaining portion 60 serves to position one axial end face of the outer ring 43a in place.

Internal-tooth structural portion 19 is formed integral with the outer peripheral side of the front end section of sprocket body 1a, and formed into a cylindrical shape forwardly extending toward the phase conversion mechanism 4. The internal-tooth structural portion is formed on its inner periphery with a plurality of waveform internal teeth 19a.

The rear end side of an annular female screw-thread structural portion 6, which is formed integral with a motor housing 5 (described later), and the front end side of internal-tooth structural portion 19 are arranged to be axially opposed to each other.

Furthermore, an annular retainer plate 61 is located at the rear end of sprocket body 1a, facing apart from the internal-tooth structural portion 19. Retainer plate 61 is made from a metal plate. As shown in FIG. 1, the outside diameter of retainer plate 61 is dimensioned to be approximately equal to that of the sprocket body 1a. The inside diameter of retainer plate 61 is dimensioned to be less than that of the outer ring 43a of large-diameter ball bearing 43.

The inner peripheral portion 61a of retainer plate 61 is kept in abutted-engagement with the outside end face of the outer ring 43a in the axial direction. Also, the inner peripheral portion 61a of the annular retainer plate has a radially-inward protruding stopper 61b integrally formed at a given circumferential angular position of the inner peripheral portion 61a, and configured to protrude toward the central axis of the retainer plate.

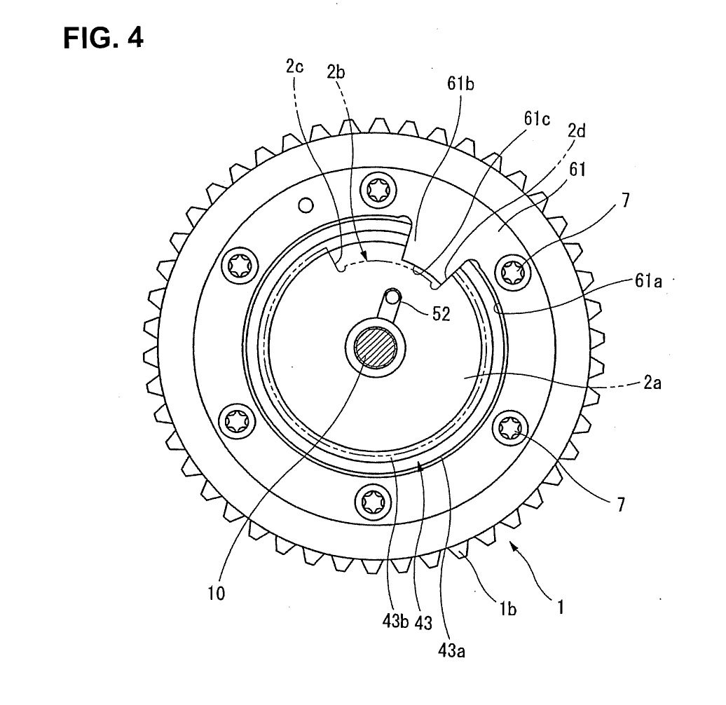

As shown in FIGS. 1 and 4, the protruding stopper 61b is formed into a substantially sector. The innermost edge 61c of stopper 61b is configured to be substantially conformable to a shape of the circular-arc peripheral surface of a stopper recessed groove 2b (described later). Additionally, the outer peripheral portion of retainer plate 61 is formed with circumferentially equidistant-spaced, six bolt insertion holes 61d (through holes) through which bolts 7 are inserted.

In a similar manner to the six bolt insertion holes 61d (through holes) formed in the retainer plate 61, the outer peripheral portion of sprocket body 1a (internal-tooth structural portion 19) is formed with circumferentially equidistant-spaced, six bolt insertion holes 1c (through holes). Also, the female screw-thread structural portion 6 is formed with six female screw threads 6a configured to be conformable to respective circumferential positions of bolt insertion holes 1c (bolt insertion holes 61d). Hence, the timing sprocket 1, the retainer plate 61, and the motor housing 5 are integrally connected to each other by axially fastening them together with six bolts 7 inserted.

By the way, the sprocket body 1a and the internal-tooth structural portion 19 are structured as a casing for a speed reducer 8 (described later).

Also, the respective outside diameters of sprocket body 1a, internal-tooth structural portion 19, retainer plate 61, and female screw-thread structural portion 6 are set or dimensioned to be approximately equal to each other.

As shown in FIG. 1, chain cover 49 is laid out and bolted onto the front end side of a cylinder block (not shown) and cylinder head 01 (an engine main body) in a manner so as to vertically extend for covering the timing chain (not shown) wound on the timing sprocket 1. Chain cover 49 has an annular wall 49a constructing an opening 49a, which is configured to be conformable to the contour of phase converter 4. Also, four boss sections 49b are integrally formed at four circumferential angular positions of annular wall 49a. Also, four female screw-threads 49c are machined in respective boss sections 49b such that female screw-threads 49c extend from the front end face of the annular wall 49a into the respective boss sections 49b.

As shown in FIGS. 1-2, cover member 3 is made from aluminum alloy and formed into a substantially cup shape. The cover member 3 is comprised of a cup-shaped cover main body 3a and an annular mounting flange 3b formed integral with the circumference of the right-hand side opening end of cover main body 3a. Cover main body 3a is configured to cover the front end of motor housing 5. A cup-shaped clearance space 32 is defined between the inside face 3f of cover member 3 and the outside face of the front end of motor housing 5.

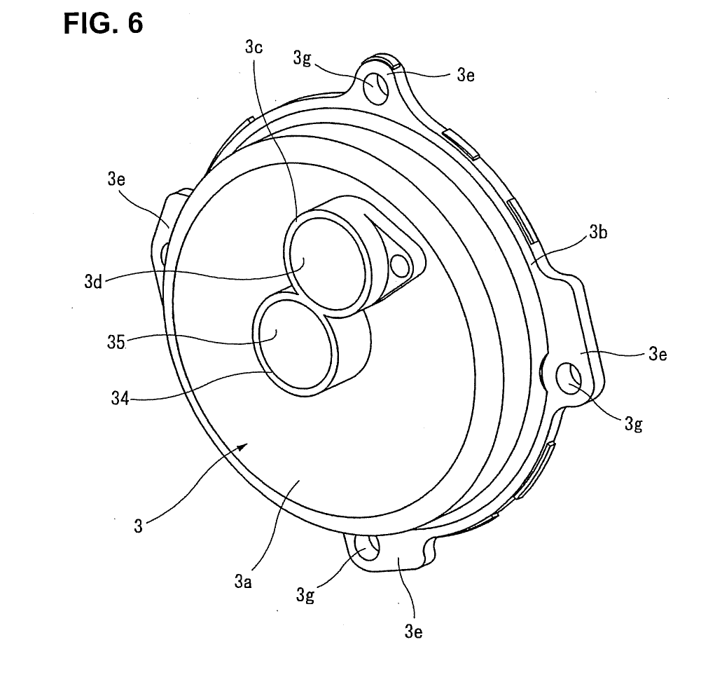

As shown in FIG. 6, cover main body 3a has a slightly axially-extending cylindrical wall portion 3c integrally formed at a given position deviated from the center of the cover main body. The cylindrical wall portion 3c has a retaining hole 3d (an axial through hole) formed therein.

A cylindrical portion 34 is also provided underneath the cylindrical wall portion 3c of cover main body 3a and arranged in parallel with the cylindrical wall portion 3c in a manner so as to protrude in the axial direction. The upper part of cylindrical portion 34 and the lower part of cylindrical wall portion 3c are integrally formed with each other. The cylindrical portion 34 has a communicating hole 35 (an axial through hole) formed therein, for communicating between the outside of cover main body 3a and the clearance space 32. A seal cap 56, which serves as a ventilation plug, is press-fitted and fixed into the outer end side of cylindrical portion 34.

Concrete configurations of the above-mentioned cylindrical portion 34, communicating hole 35, and seal cap 56 are described later.

The previously-discussed mounting flange 3b is integrally formed with circumferentially equidistant-spaced, four tab-like portions 3e configured to protrude radially outward and circumferentially spaced from each other by approximately 90 degrees. As shown in FIG. 1, bolt insertion holes 3g (through holes) are bored in respective tab-like portions 3e. Cover member 3 is fixedly connected to the chain cover 49 by means of bolts 54, which are inserted through the respective bolt insertion holes 3g and screwed into the female screw-threads 49d formed in the respective boss sections of chain cover 49.

A large-diameter oil seal 50 is interleaved between the shouldered inner peripheral surface inside of the circumference of cover main body 3a and the outer peripheral surface of motor housing 5. Large-diameter oil seal 50 is formed into a substantially C-shape in lateral cross section. Oil seal 50 is made from synthetic rubber (a base material), and also a core metal is buried ‘in the base material. The outer peripheral annular base-material wall section of oil seal 50 is fitted and fixed to the shouldered annular groove portion 3h formed in the inner peripheral surface of cover member 3. The large-diameter oil seal 50 is configured to seal the clearance space 32 in a fluid-tight fashion, thereby mainly suppressing entry of lubricating oil, scattered from the rotationally driven sprocket 1, into the clearance space 32.

As shown in FIG. 1, motor housing 5 is comprised of a housing main body 5a made from iron-based metal material and formed into a substantially cylindrical shape with a bottom face by pressing, and an electricity-feeding plate 11 provided for sealing the axially forward opening of housing main body 5a.

Housing main body 5a has a disk-shaped partition wall 5b formed at its rear end. Housing main body 5a is also formed at a substantially center of the partition wall 5b with a large-diameter eccentric-shaft insertion hole 5c into which an eccentric shaft 39 (described later) is inserted. An axially extending cylindrical portion 5d is formed integral with the annular edge of eccentric-shaft insertion hole 5c in a manner so as to protrude in the axial direction of camshaft 2. Also, female screw-thread structural portion 6 is integrally formed on the outer periphery of the front end face of partition wall 5b.

Camshaft 2 has two drive cams integrally formed on its outer periphery for operating the associated two intake valves (not shown) per one engine cylinder. Also, camshaft 2 has a flanged portion 2a integrally formed at its front end section.

As shown in FIG. 1, the outside diameter of flanged portion 2a is dimensioned to be slightly greater than that of a fixed-end portion 9a of the driven member 9 (described later). Hence, after installation of all component parts, the circumference of the front end face of the flanged portion is brought into abutted-engagement with the axially outside end face of the inner ring 43b of large-diameter ball bearing 43. Under a state where the front end face of flanged portion 2a has been brought into axially abutted-engagement with the driven member 9, the driven member and the camshaft flanged portion are axially connected to each other by means of a cam bolt 10.

As shown in FIG. 4, the outer periphery of flanged portion 2a is partially cut or formed as the stopper groove 2b recessed along the circumferential direction. The stopper recessed groove 2b is brought into engagement with the protruding stopper 61b of retainer plate 61. The stopper recessed groove 2b is formed into a circular-arc shape having a specified circumferential length to permit a circumferential movement of the protruding stopper 61b within a limited motion range determined based on the specified circumferential length. Hence, a maximum phase-advance position of camshaft 2 relative to timing sprocket 1 is restricted by abutment between the counterclockwise edge of protruding stopper 61b and the clockwise face 2c of the circumferentially opposing two inner end faces of the stopper recessed groove. On the other hand, a maximum phase-retard position of camshaft 2 relative to timing sprocket 1 is restricted by abutment between the clockwise edge of protruding stopper 61b and the counterclockwise face 2d of the circumferentially opposing two inner end faces of the stopper recessed groove.

By the way, the previously-noted protruding stopper 6lb is somewhat displaced toward the side of camshaft 2 with respect to the inner peripheral retaining portion of retainer plate 61, which retaining portion is configured to axially face and retain the outer ring 43a of large-diameter ball bearing 43. Thus, the protruding stopper 61b is kept in a spaced, contact-free relationship with the fixed-end portion 9a of driven member 9 in the axial direction, thereby suppressing undesirable interference between the protruding stopper 61b and the fixed-end portion 9a.

As shown in FIG. 1, cam bolt 10 is comprised of a head 10a and a shank 10b. The axial end face of the head 10a is configured to support the inner ring of a small-diameter ball bearing 37 in the axial direction. Also, the cam bolt is formed on the outer periphery of shank 10b with a male screw-threaded portion 10c, which is screwed into a female screw-threaded portion machined into the axial end of camshaft 2 along the internal axial direction.

Driven member 9 is made from iron-based metal material. As shown in FIG. 1, the driven member 9 is comprised of the disk-shaped fixed-end portion 9a formed on the rear end side (on the side of camshaft 2), an axially-forward-extending cylindrical portion 9b formed integral with the front end face of fixed-end portion 9a, and a cylindrical cage 41, which cage is formed integral with the outer periphery of fixed-end portion 9a and configured to hold a plurality of rollers 48.

The rear end face of fixed-end portion 9a is arranged to abut with the front end face of the flanged portion 2a of camshaft 2, and fixedly connected to and kept in press-contact with the flanged portion 2a by an axial force of cam bolt 10.

As shown in FIG. 1, the previously-noted cylindrical portion 9b is formed with a central bore 9d into which the shank 10b of cam bolt 10 is inserted. A needle bearing 38 (a bearing member) is mounted on the outer periphery of cylindrical portion 9b.

As shown in FIG. 1, cage 41 is configured to further extend from the front end of the outer periphery of fixed-end portion 9a, and bent into a substantially L shape in cross section and formed into a bottomed cylindrical shape extending in the same axial direction as the cylindrical portion 9b.

The cylindrical end portion 41a of cage 41 is configured to extend toward the partition wall 5b of motor housing 5 through an annular recessed internal accommodation space 44 defined between the female screw-thread structural portion 6 and the axially extending cylindrical portion 5d. Also, as shown in FIGS. 1-2, the cylindrical end portion 41a has a plurality of substantially rectangular roller-retaining holes 41b, which are configured to be equidistant-spaced from each other with a given circumferential interval in the circumferential direction of the cylindrical end portion. The plurality of rollers 48 are rotatably held or retained in the respective roller-retaining holes. The roller-retaining holes 41b (rollers 48) are configured such that the number of the roller-holding holes is fewer than the number of the internal teeth 19a of internal-tooth structural portion 19, thereby achieving a prescribed reduction gear ratio.

Phase conversion mechanism 4 is mainly constructed by the electric motor 12 located at the front end side of cylindrical portion 9b of driven member 9, and the speed reducer 8 provided for reducing the rotational speed of electric motor 12 and for transmitting the reduced motor speed to the camshaft 2.

As shown in FIGS. 1-2, electric motor 12 is a brush-equipped direct-current (DC) motor. Electric motor 12 is comprised of the motor housing 5 serving as a yoke that rotates together with the timing sprocket 1, a motor output shaft 13 rotatably installed in the motor housing 5, a pair of semi-circular permanent magnets 14, 15 serving as a stator fixed onto the inner peripheral surface of motor housing 5, and the electricity-feeding plate 11.

Motor output shaft 13 is formed into a shouldered cylindrical-hollow shape, and serves as an armature. Motor output shaft 13 is constructed by a large-diameter portion 13a facing on the side of camshaft 2 and a small-diameter portion 13b facing apart from the side of camshaft 2, both integrally formed with each other through a shouldered portion 13c substantially at a midpoint of the axially-extending cylindrical-hollow motor output shaft. An iron-core rotor 17 is fixedly connected onto the outer periphery of large-diameter portion 13a. Also, large-diameter portion 13a is formed at its rear end integral with the eccentric shaft 39, which constructs part of the speed reducer 8.

On the other hand, regarding small-diameter portion 13b, an annular member 20 is press-fitted onto the outer periphery of the small-diameter portion. A commutator 21 (describer later) is axially press-fitted onto the outer peripheral surface of annular member 20, in a manner so as to be axially positioned in place by the axial end face of shouldered portion 13c. The outside diameter of annular member 20 is dimensioned to be approximately equal to that of large-diameter portion 13a. The axial length of annular member 20 is dimensioned to be slightly shorter than that of small-diameter portion 13b.

Furthermore, a plug 55 is press-fitted and fixed to the inner peripheral surface of small-diameter portion 13b, for suppressing undesirable leakage of lubricating oil, which oil is supplied into the motor output shaft 13 and eccentric shaft 39 for lubrication of the previously-discussed ball bearing 37 and needle bearing 38, to the outside.

Iron-core rotor 17 is formed by a magnetic material having a plurality of magnetic poles. The outer periphery of iron-core rotor 17 is constructed as a bobbin having slots on which the winding of each of coils 18 is wound.

Commutator 21 is formed as a substantially annular shape and made from a conductive material. Commutator 21 is divided into a plurality of segments whose number is equal to the number of magnetic poles of iron-core rotor 17. Terminals of the coil winding drawn out from coil 18 are electrically connected to each of these segments of the commutator.

As a whole, the previously-discussed permanent magnets 14, 15 are formed into a cylindrical shape, and have a plurality of magnetic poles in the circumferential direction. The axial position of each of permanent magnets 14, 15 is offset from the axial center of iron-core rotor 17 toward the electricity-feeding plate 11. Hence, the front ends of permanent magnets 14, 15 are arranged to overlap with switching brushes 25a, 25b and the like (described later) installed on the commutator 21 and electricity-feeding plate 11 in the radial direction.

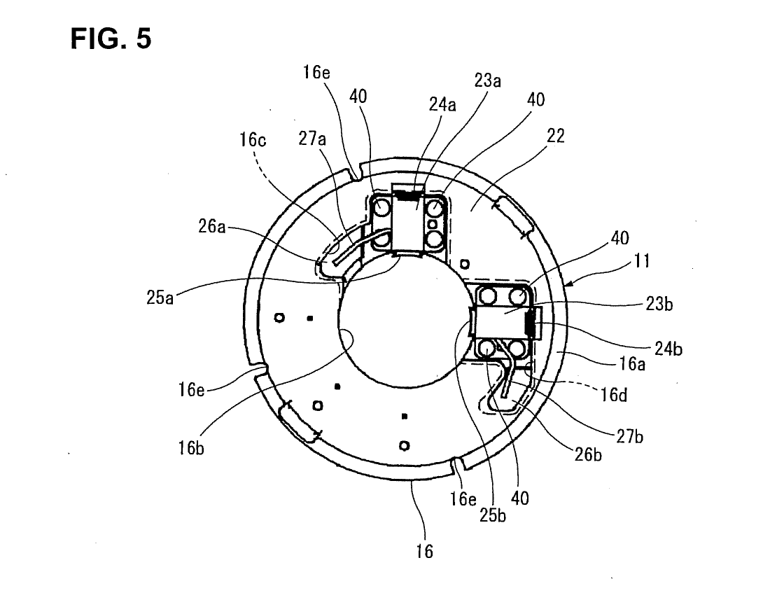

As shown in FIGS. 5-7, the previously-discussed electricity-feeding plate 11 is comprised of a disk-shaped metal rigid plate 16 (a fixing plate) made from iron-based metal material and a resin section 22 molded to both side faces of the rigid plate 16 in the fore-and-aft direction. The electricity-feeding plate 11 constructs a part of an electricity-feeding mechanism for electricity-feeding to the electric motor 12.

As shown in FIG. 1, an outer peripheral portion 16a (not surrounded by the resin section 22) of rigid plate 16 is positioned and fixed to an annular stepped recessed groove 5e formed in the inner periphery of the front end section of motor housing 5 by caulking. The rigid plate 16 is formed at its center with a shaft insertion hole 16b, into which one end of motor output shaft 13 is inserted. As shown in FIGS. 5-6, the rigid plate 16 has two deformed retaining holes 16c, 16d formed by punching at respective predetermined positions being continuous with the inner peripheral edge of the shaft insertion hole 16b. Brush holders 23a, 23b (described later) are fitted and retained into respective retaining holes 16c, 16d.

By the way, three U-shaped grooves 16e are formed at respective predetermined circumferential positions of the outer peripheral portion 16a, for circumferentially positioning the rigid plate with respect to the housing main body 5a through a jig (not shown).

As shown in FIGS. 1 and 5, the above-mentioned electricity-feeding plate 11 is equipped with a pair of copper brush holders 23a, 23b, a pair of switching brushes 25a, 25b, inner and outer double electricity-feeding slip rings 26a, 26b, and harnesses 27a, 27b. The copper brush holders are arranged inside of respective retaining holes 16c, 16d of rigid plate 16, and fixed to the front end section 22a of resin section 22 by a plurality of rivets 40. The pair of switching brushes 25a, 25b are accommodated and held in respective brush holders 23a, 23b so as to be radially slidable. The circular-arc shaped top end faces of these switching brushes are kept in elastic-contact (sliding-contact) with the outer peripheral surface of commutator 21 by respective spring forces of coil springs 24a, 24b. The inner and outer double electricity-feeding slip rings 26a, 26b are attached to the front end section 22a of resin section 22, such that the outside face of each of these electricity-feeding slip rings is partially exposed and that the inside of each of these electricity-feeding slip rings is buried or molded in the front end side of resin section 22. The harness 27a is provided to electrically connect the switching brush 25a to the slip ring 26a, while the harness 27b is provided to electrically connect the switching brush 25b to the slip ring 26b. These component parts, that is, the brush holders, the switching brushes, the slip rings, and the harnesses, and the electricity-feeding plate 11 construct the electricity-feeding mechanism. The inner peripheral side small-diameter slip ring 26a and the outer peripheral side large-diameter slip ring 26b are made from a thin copper plate and formed into an annular shape by punching.

A brush retainer 28, which is integrally molded of a synthetic resin material, is fixedly connected to the cover main body 3a of cover member 3. As shown in FIGS. 1-2, brush retainer 28 is formed into a substantially crank shape in side view. Brush retainer 28 is mainly comprised of a substantially cylindrical bottomed brush-retaining portion 28a, a connector portion 28b, a boss portion 28c, and a pair of electricity-feeding terminal strips 31, 31. Brush-retaining portion 28a is inserted into the retaining through-hole 3d of cover member 3. Connector portion 28b is integrally formed on the side opposite to the brush-retaining portion 28a. Boss portion 28c is formed as a laterally-extending tab-like portion, which is formed integral with one side face of brush-retaining portion 28a and fixedly bolted to the cover main body 3a. Most of terminal strips 31, 31 are buried in the synthetic-resin brush retainer.

As shown in FIGS. 1-2, brush-retaining portion 28a is configured to extend horizontally (axially). Brush-retaining portion 28a has a pair of prismatic retaining holes formed therein and arranged parallel to each other above the axis of motor housing 5 in the vertical direction.

A pair of rectangular parallelopiped brush holders 29a, 29b are press-fitted and fixed into the respective prismatic retaining holes. Electricity-feeding brushes 30a, 30b are retained in the respective brush holders 29a, 29b so as to be axially slidable.

As shown in FIGS. 1 and 6, an annular seal member 33 is fitted and retained in an annular groove formed in the outer periphery of the root (the basal end) of brush-retaining portion 28a. The annular seal member 33 is kept in elastic-contact with the inner peripheral surface of retaining through-hole 3d. The annular seal member 33 provides a fluid-tight sealing function between the clearance space 32 and the outside of cover member 3.

Front and rear ends of each of brush holders 29a, 29b are formed as opening ends, such that the top ends of electricity-feeding brushes 30a, 30b freely move back and forth through the respective front opening ends. One harness ends of pigtail harnesses (not shown) are connected through the respective rear end openings to rear ends of electricity-feeding brushes 30a, 30b by soldering.

Each of electricity-feeding brushes 30a, 30b is formed into a prismatic shape, and set to a predetermined axial length. Furthermore, electricity-feeding brushes 30a, 30b are arranged such that their flat top end faces axially abut against respective slip rings 26a, 26b.

A pair of coil springs 42a, 42b are provided inside of the rear ends of brush holders 29a, 29b of brush-retaining portion 28a, for permanently forcing or biasing electricity-feeding brushes 30a, 30b toward respective slip rings 26a and 26b.

As shown in FIG. 1, terminal strips 31, 31 are arranged parallel with each other so as to extend vertically and partly cranked. One end of each of these crank-shaped terminal strips (i.e., the downward terminals 31a, 31a) is exposed to the bottom of the brush-retaining portion. The other end of each of the two terminal strips (i.e., the upward terminals 31b, 31b) is configured to protrude into a female fitting groove 28d of connector portion 28b.

The one terminal ends 31a, 31a are arranged to abut with the bottom wall surface 28f of the brush-retaining portion and electrically connected to the respective other harness ends of the pigtail harnesses (not shown) by soldering.

The lengths of the pigtail harnesses are set such that electricity-feeding brushes 30a, 30b do not fall out of the brush holders 29a, 29b even when the electricity-feeding brushes are pushed forward by respective spring forces of coil springs 42a, 42b.

As previously-discussed, the connector portion 28b is formed at its upper end with the female fitting groove 28d into which the male socket (not shown) is inserted. The upward terminals 31b, 31b, which are configured to protrude into the female fitting groove 28d, are electrically connected to a control unit (not shown) via the male socket.

The motor output shaft 13 and the eccentric shaft 39 are rotatably supported by means of the small-diameter ball bearing 37 and the needle bearing 38. The small-diameter ball bearing is installed on the outer peripheral surface of shank 10b of cam bolt 10. The needle bearing is installed on the outer peripheral surface of cylindrical portion 9b of driven member 9 and axially arranged in juxtaposition with the small-diameter ball bearing 37.

Needle bearing 38 is comprised of a cylindrical retainer 38a press-fitted into the inner peripheral surface of eccentric shaft 39 and a plurality of needle rollers 38b (rolling elements) rotatably retained inside of the retainer 38a. Each of needle rollers 38b is in rolling-contact with the outer peripheral surface of cylindrical portion 9b of driven member 9.

Regarding the small-diameter ball bearing 37, its inner ring is fixed in a manner so as to be sandwiched between the front end edge of cylindrical portion 9b of driven member 9 and the head 10a of cam bolt 10. On the other hand, its outer ring is press-fitted to the stepped diameter-enlarged inner peripheral surface of eccentric shaft 39, and thus axial positioning of the outer ring is made by abutment with the stepped edge of the diameter-enlarged inner peripheral surface.

A small-diameter oil seal 46 is interleaved between the outer peripheral surface of motor output shaft 13 (eccentric shaft 39) and the inner peripheral surface of the axially extending cylindrical portion 5d of motor housing 5, for preventing leakage of lubricating oil from the inside of speed reducer 8 toward the inside of electric motor 12. Small-diameter oil seal 46 serves as a partition having a sealing function between electric motor 12 and speed reducer 8.

The previously-discussed control unit is configured to detect the current engine operating condition based on input informational signals from various sensors (not shown), namely, a crank angle sensor, an airflow meter, a water temperature sensor, an accelerator opening sensor, and the like, for executing engine control based on the current engine operating condition. Also, the control unit is configured to electricity-feed to each of coils 18 via the electricity-feeding brushes 30a, 30b, slip rings 26a, 26b, switching brushes 25a, 25b, and commutator 21 for carrying out rotation control of motor output shaft 13, thus controlling a relative rotational phase of camshaft 2 to timing sprocket 1 through the use of the speed reducer 8.

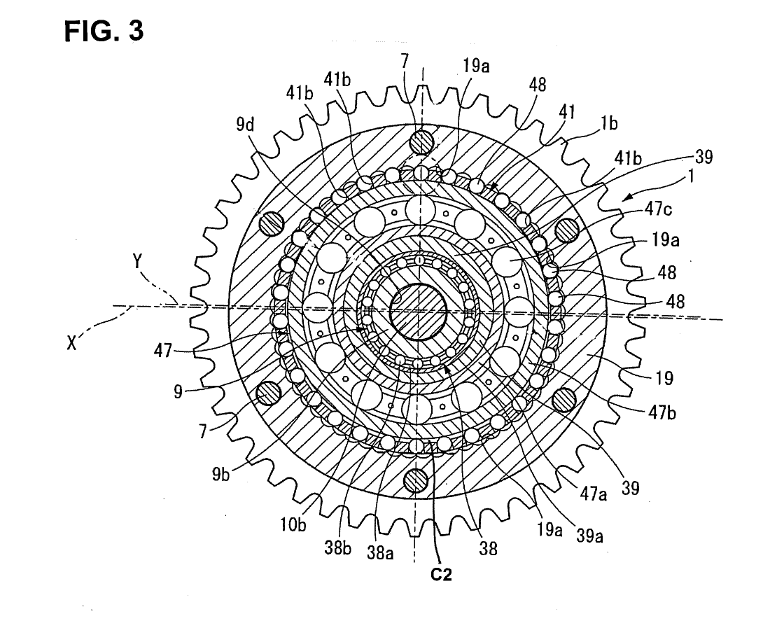

As shown in FIGS. 1-3, speed reducer 8 is mainly comprised of the eccentric shaft 39 that performs eccentric rotary motion, a middle-diameter ball bearing 47 installed on the outer periphery of eccentric shaft 39, rollers 48 installed on the outer periphery of middle-diameter ball bearing 47, cage 41 configured to retain and guide these rollers 48 in the direction of rolling movement of these rollers, while permitting a radial displacement (an oscillating motion) of each of rollers 48, and the driven member 9 formed integral with the cage 41.

The geometric center “Y” of the cam contour surface 39a, formed on the outer periphery of the eccentric shaft 39, is slightly displaced from the axis “X” of motor output shaft 13 in the radial direction.

Most of middle-diameter ball bearing 47 is arranged to radially overlap with the needle bearing 38. Middle-diameter ball bearing 47 is comprised of an inner ring 47a, an outer ring 47b, and balls 47c rotatably disposed and confined between inner and outer rings 47a, 47b. The inner ring 47a is press-fitted onto the outer peripheral surface (the eccentric-cam contour surface) of eccentric shaft 39. In contrast to the inner ring, the outer ring 47b is not securely fixed in the axial direction, such that the outer ring is free and therefore is able to move contact-free. That is, one sidewall surface of the outer ring 47b, axially facing the side of electric motor 12, is kept out of contact with any part of the motor housing, while the other sidewall surface of the outer ring, axially opposed to the inside wall surface of cage 41, is kept in spaced, contact-free relationship with the inside wall surface of the cage with a minute first clearance C. Also, rollers 48 are held in rolling-contact with the outer peripheral surface of outer ring 47b. Additionally, a crescent-shaped annular second clearance C1 is defined on the outer peripheral side of outer ring 47b. Owing to eccentric rotary motion of eccentric shaft 39, middle-diameter ball bearing 47 can be radially displaced by virtue of the annular second clearance C1, thus ensuring eccentric displacement of the middle-diameter ball bearing.

Each of rollers 48 is made from iron-based metal material. Owing to the eccentric displacement of middle-diameter ball bearing 47, some of rollers 48 are brought into fitted-engagement into some troughs of internal teeth 19a of internal-tooth structural portion 19, while radially moving. That is, owing to the eccentric displacement, each of rollers 48 can radially oscillate, while being circumferentially guided by both inside edges of each of roller-retaining holes 41b of cage 41.

Also provided is a lubricating-oil supply means for supplying lubricating oil into the internal space of speed reducer 8. The lubricating-oil supply means is comprised of an oil supply passage which is formed in the journal bearing 02 of the cylinder head 01 and to which lubricating oil is supplied from a main oil gallery (not shown), an oil supply hole 51 formed in the camshaft 2 so as to extend axially and configured to communicate the oil supply passage via an oil groove 51b, a small-diameter oil hole 52, and an oil drain hole (not shown) formed through the driven member 9. Small-diameter oil hole 52 is formed as an axially-extending through hole in the driven member 9, such that one end of the small-diameter oil hole is opened into the oil supply hole 51 and the other end of the small-diameter oil hole is opened into the internal space defined near both the needle bearing 38 and the middle-diameter ball bearing 47.

By the previously-discussed lubricating-oil supply means, lubricating oil can be supplied into and retained in the above-mentioned accommodation space 44. Then, the lubricating oil is supplied from the internal space to moving parts, namely, middle-diameter ball bearing 47 and rollers 48 for lubrication, and further flows into the eccentric shaft 39 and the internal space of motor output shaft 13, for lubrication of moving parts, such as needle bearing 38 and small-diameter ball bearing 37. By the way, undesirable leakage of lubricating oil, flown into and retained in the accommodation space 44, to the inside of the motor housing 5 can be prevented or adequately suppressed by means of the small-diameter oil seal 46.

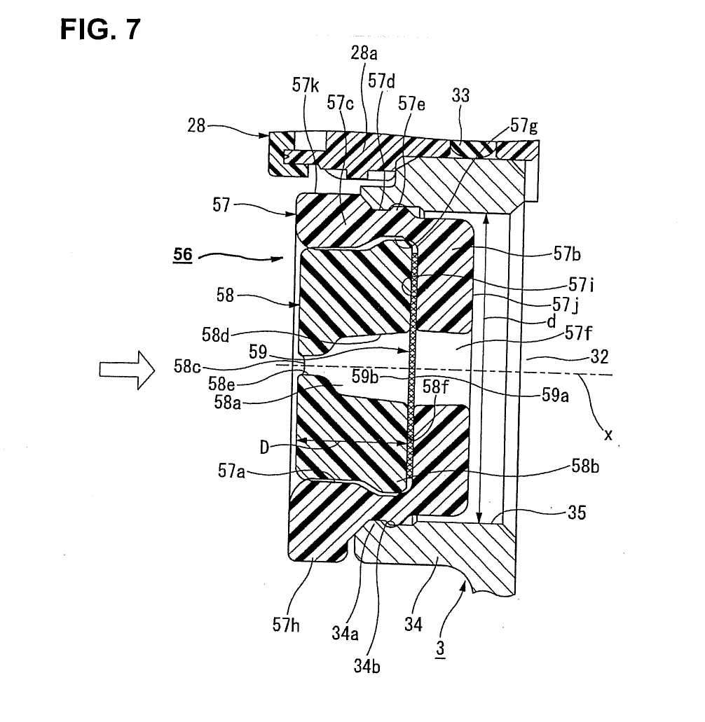

As shown in FIGS. 1 and 7, the previously-discussed cylindrical portion 34, which is provided on the cover member 3, has an annular retaining protruded section 34a and an annular retaining recessed section 34b, both integrally formed in the inner periphery of the top end of cylindrical portion 34. The retaining recessed section 34b is arranged inside of the retaining protruded section 34a. The inside diameter of the retaining protruded section 34a is dimensioned to be approximately equal to the inside diameter “d” of the communicating hole 35. The inside diameter of the retaining recessed section 34b is dimensioned to be slightly greater than the inside diameter “d” of the communicating hole 35. The retaining protruded section 34a and the retaining recessed section 34b combine together to form a stepped shape of protrusion-and-recess fitting.

The previously-discussed communicating hole 35 (the cylindrical portion 34) functions as a positioning work hole for adjusting a relative position between the cylindrical-hollow motor output shaft 13 and the cover member 3 after the cover member 3 has been installed on the chain cover 49. The center of communicating hole 35 is formed to be approximately coaxial with the axis “X” of the cylindrical-hollow motor output shaft 13. The inside diameter “d” of the communicating hole 35 is dimensioned to be slightly greater than the inside diameter of the motor output shaft 13.

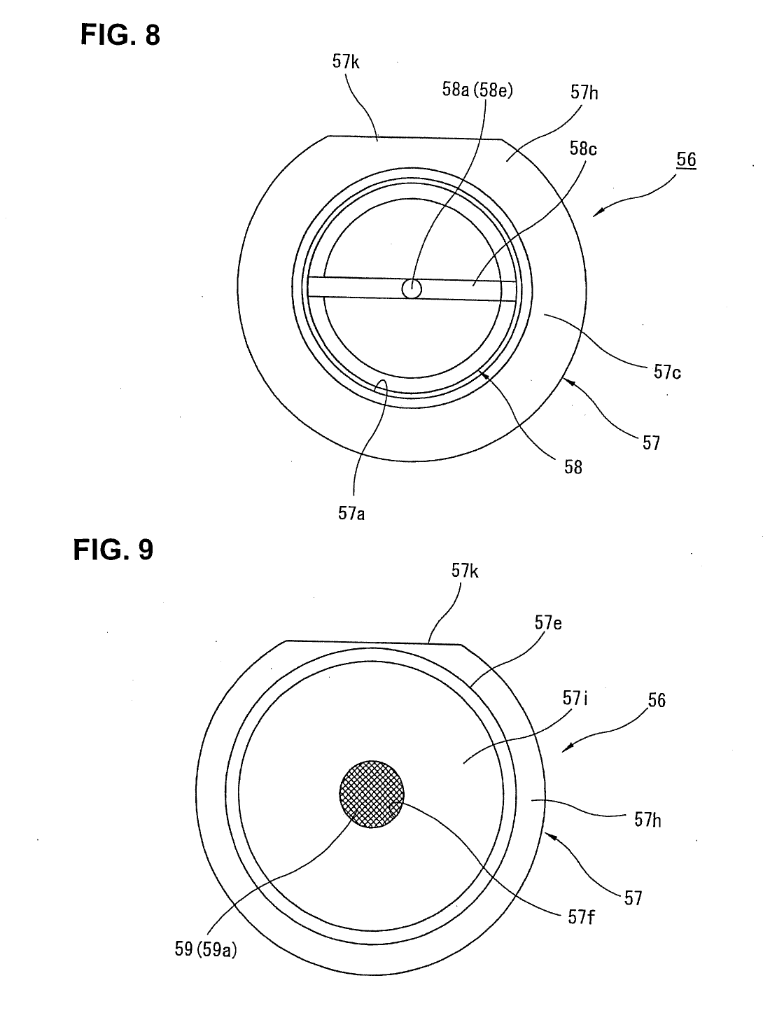

As shown in FIGS. 7-9, a seal cap 56 is formed into a substantially C-shape in longitudinal cross-section. Seal cap 56 is comprised of a bottomed cylindrical cap main body 57 having a recessed groove 57a formed in a substantially center of the outside end face of the cap main body, a supporting portion 58, which is a fitting portion press-fitted into the recessed groove 57a of cap main body 57, and a circular ventilation filter 59 installed and located on a bottom face 57i of the recessed groove 57a, such that the ventilation filter is retained and sandwiched between the bottom face 57i and the supporting portion 58.

The previously-discussed cap main body 57 is integrally formed and made from an elastically deformable synthetic resin material. The cap main body 57 has an annular engaging groove 57d and an annular engaging protrusion 57e, both of which are integrally formed in the outer peripheral surface of a bottom wall 57b and an outer peripheral wall 57c, both walls defining the recessed groove 57a. The annular engaging groove 57d engages with the retaining protruded section 34a of cylindrical portion 34, whereas the annular engaging protrusion 57e is arranged axially inside of the annular engaging groove 57d and engages with the retaining recessed section 34b.

A first ventilation hole 57f is formed in a substantially central position of the bottom wall 57b constructing part of the recessed groove 57a, such that the first ventilation hole penetrates through the cap main body along the axial direction. The first ventilation hole is formed into a circular shape in cross section, and its inside diameter is uniform in the axial direction. Also, the cap main body has an annular fitting groove 57g formed in the inner peripheral surface near the bottom face 57i.

The circumference of the front end side of the outer peripheral wall 57c is integrally formed with a flanged protrusion 57h. When the cap main body 57 has been engageably inserted and fitted into the distal-end opening of communicating hole 35, the flanged protrusion 57h is brought into abutted-engagement with the outer opening edge of communicating hole 35 in the axial direction, for restricting an excessive insertion of the cap main body into the communication hole for the purpose of coming-off.

The flanged protrusion 57h is formed with a clearance groove (cut groove) 57k partly cut the upper part along the tangential direction, for the purpose of avoiding the interference of the upper part of the flanged protrusion 57h with the lower part of brush-retaining portion 28a.

The previously-discussed supporting portion 58 is made from an elastically deformable synthetic resin material, and integrally formed into a substantially annular shape. The axial thickness dimension of supporting portion 58 is dimensioned to be slightly less than the depth “D” of the recessed groove 57a. A second ventilation hole 58a (a ventilation hole of the fitting portion) is formed in a substantially central position of the supporting portion 58, such that the second ventilation hole penetrates through the supporting portion along the axial direction, and that the second ventilation hole communicates with the first communication hole.

Also, supporting portion 58 is integrally formed at its innermost end facing the recessed-groove bottom face 57i of cap main body 57 with a fitting protrusion 58b. The fitting protrusion 58b is fitted and fixed to the fitting groove 57g of cap main body 57.

Furthermore, a linear groove 58c is formed in the outside end face of supporting portion 58 along the diametrical direction, for preventing erroneous installation of the supporting portion 58 into the recessed groove 57a of cap main body 57.

The second ventilation hole 58a is formed into a bell-mouth shape diametrically enlarged from its outermost axial end to its innermost axial end facing onto the side of the first ventilation hole 57f. A passage part 58d of the innermost axial end is formed as a large-diameter section, whereas a vent port 58e of the outermost axial end is formed as a small-diameter section. By virtue of the reduced diameter of vent port 58e, it is possible to suppress undesirable entry of water, dust and/or debris from the outside to the inside.

The previously-discussed ventilation filter 59 is constructed by a flexibly deformable thin filter-cloth, which is formed into a disc shape. The outside diameter of the ventilation filter is dimensioned to be less than the inside diameter of the recessed-groove bottom face 57i of cap main body 57. The whole body of ventilation filter 59 is configured to be kept in closely contact with the bottom face 57i. To prepare a subassembly, first of all, the cap main body 57 is horizontally held, and then the ventilation filter 59 is inserted into the recessed groove 57a of the horizontally-held cap main body and thus pre-mounted on the bottom face 57i. Under this condition, by press-fitting the supporting portion 58 into the recessed groove 57a, the ventilation filter 59 is fixed (retained) and sandwiched between the recessed-groove bottom face 57i and a front end face 58f of supporting portion 58, facing the bottom face 57i.

Furthermore, ventilation filter 59 has both sides, that is, a primary side 59a (the right side) facing onto the side of the supporting portion 58 and a secondary side 59b (the back side) facing onto the side of the recessed-groove bottom face 57i. The ventilation filter 59 is formed from a base material that permits permeation of air from the primary side 59a to the secondary side 59b and that suppresses (or prevents) permeation of liquid and dust from the secondary side 59b to the primary side 59a.

### Operation of Embodiment

The operation of the valve timing control device of the embodiment is hereunder described in detail. When the engine crankshaft is driven, timing sprocket 1 rotates in synchronism with rotation of the crankshaft through the timing chain. A rotational force (torque) is transmitted from the timing sprocket through the internal-tooth structural portion 19 and the female screw-thread structural portion 6 to the motor housing 5, and thus the motor housing 5 rotates synchronously. On the other hand, a rotational force (torque) of internal-tooth structural portion 19 is transmitted via the rollers 48, cage 41, and driven member 9 to the camshaft 2, thereby enabling the cams of camshaft 2 to operate (open/close) the intake valves.

During a given engine operating condition after the engine start-up, an electric current is applied from the control unit through the terminal strips 31, 31, the pigtail harnesses, electricity-feeding brushes 30a, 30b, and slip rings 26a, 26b to each of coils 18 of electric motor 12. Hence, motor output shaft 13 is driven. Then, the output rotation from the motor output shaft is reduced by means of the speed reducer 8, and thus the reduced speed (in other words, the multiplied torque) is transmitted to the camshaft 2.

That is to say, when eccentric shaft 39 rotates eccentrically according to rotation of motor output shaft 13, each of rollers 48 moves (rolls) and relocates from one of two adjacent internal teeth 19a, 19a of internal-tooth structural portion 19 to the other with one-tooth displacement per one complete revolution of motor output shaft 13, while being radially guided by the associated roller-holding hole 41b of cage 41. By way of the repeated relocations of each of rollers 48 every revolutions of motor output shaft 13, these rollers move in the circumferential direction with respect to the internal-tooth structural portion, while being held in rolling-contact with the middle ball bearing outer ring. By means of the rolling-contact of each of rollers 48, the output rotation from motor output shaft 13 is reduced and thus the reduced speed (in other words, the multiplied torque) is transmitted to the driven member 9. By the way, the reduction ratio of this type of speed reducer can be arbitrarily set depending on the difference between the number of internal teeth 19a and the number of rollers 48.

As discussed above, camshaft 2 is rotated in a normal-rotational direction or in a reverse-rotational direction relatively to the timing sprocket 1, and thus a relative-rotational phase of camshaft 2 to timing sprocket 1 is changed or converted, and as a result conversion control for intake valve open timing (IVO) and intake valve closure timing (IVC) to the phase-advance side or to the phase-retard side can be achieved.

By the way, a maximum phase-conversion position of camshaft 2 relative to timing sprocket 1 in the normal-rotational direction or in the reverse-rotational direction is restricted by abutment between the counterclockwise edge of protruding stopper 61b and the clockwise edge 2c of stopper groove 2b or abutment between the clockwise edge of protruding stopper 61b and the counterclockwise edge 2d of stopper groove 2b.

Therefore, the intake-valve open/closure timing can be converted into a maximum phase-advance side or into a maximum phase-retard side. This contributes to the improved fuel economy and enhanced engine power output.

In the valve timing control device of the embodiment, the clearance space 32 is sealed in a fluid-tight fashion by means of the large-diameter oil seal 50 and the annular seal member 33, but the seal cap 56 is installed and fitted to the cylindrical portion 34 of cover member 3. Therefore, during driving (operation) of the device, a temperature rise in the clearance space 32 occurs owing to frictional heat generated during sliding-motion of slip rings 26a, 26b relative to electricity-feeding brushes 30a, 30b. Even when such a temperature rise is occurring, air in the clearance space 32 can be rapidly exhausted by way of the first ventilation hole 57f, the ventilation filter 59, and the second ventilation hole 58a. Hence, it is possible to effectively suppress a rise of internal pressure in the clearance space 32. As a result of this, it is possible to satisfactorily suppress undesirable deformation and accidental coming-off of component parts, including, for instance, the previously-discussed large-diameter oil seal 50, annular seal member 33 and the like.

Additionally, the previously-discussed ventilation filter 59 is configured to permit permeation of air from within the clearance space 32 and permeation of outside air from the outside of the cover member 3, and simultaneously suppress permeation of water liquid, debris and/or debris from the outside of the cover member 3. Hence, it is possible to suppress undesirable entry of water, dust and/or debris into the clearance space 32.

Prior to assembling the whole body of seal cap 56 into the communicating hole 35, component parts, including the cap main body 57 and the like, are pre-assembled. As such a pre-assembling process, first of all, the cap main body 57 is horizontally held or mounted on the upside of a base, such that the inside end face 57j of cap main body 57 faces downwards. Thereafter, the ventilation filter 59 is inserted into the recessed groove 57a and thus pre-mounted on the bottom face 57i. Under this condition, by pushing the supporting portion 58 by a finger against an elastic force and by press-fitting the supporting portion through the front end opening of the recessed groove 57a into the inside of the recessed groove, the fitting protrusion 58b of supporting portion 58 is brought into fitted-engagement with the fitting groove 57g of cap man body 57 with elastic deformation of the fitting protrusion 58b. At the same time, the ventilation filter 59 is fixed (retained) and sandwiched between the bottom face 57i of recessed groove 57a and the front end face 58f of supporting portion 58.

In this manner, both the supporting portion 58 and the ventilation filter 59 can be easily fixed or pre-assembled on the cap main body 57 with one operation, thus facilitating the assembling work of both the supporting portion 58 and the ventilation filter 59 on the cap main body 57.

Subsequently to the above, when installing the seal cap 56, which is combined or pre-assembled into a unit, into the communicating hole 35, as shown in FIG. 7, first of all, the bottom wall 57b of cap main body 57 is aligned with the distal-end opening of communicating hole 35. Thereafter, with the bottom wall aligned with the distal-end opening, by pushing the central position of the outside end face of supporting portion 58, facing onto the vent port 58e of the second ventilation hole 58a, toward the bottom face 57i of recessed groove 57a by the finger, the annular engaging protrusion 57e is brought into elastic-engagement (elastic-contact) with the retaining recessed section 34b of the cylindrical portion 34 with flexible deformation (deflection) of the annular engaging protrusion 57e. At the same time, the annular engaging groove 57d is brought into elastic-engagement (elastic-contact) with the retaining protruded section 34a. Thereby, the seal cap 59 can be easily but certainly installed into the distal-end opening of communicating hole 35 of cylindrical portion 34 with one operation.

To the contrary, let us suppose that the structure of seal cap 56 is altered such that the recessed groove 57a is formed on the inside end side of cap main body 57 (that is, on the side of electric motor 12), the supporting portion 58 is fitted to and retained in the recessed groove 57a from the outside, and the previously-discussed ventilation filter 59 is fixed (retained) and sandwiched between the bottom face of the recessed groove 57a and the supporting portion 58. In such a case, the recessed groove 57a opens toward the side of electric motor 12. When installing or assembling the cap main body 57 into the communicating hole 35, the cap main body 57 itself has to be pushed into the communicating hole 35 from the outside by a worker. This is because the supporting portion 58 has already been fitted and pre-assembled into the recessed groove 57a formed on the inside end side of cap main body 57. Therefore, there is a possibility that the supporting portion 58 comes off the recessed groove 57a by the force pushing the cap main body and thus the supporting portion 58 falls into the communicating hole 35 (that is, toward the side of electric motor 12).

As a result of this, seal cap 56 has to be reassembled and reinstalled. This leads to a degradation in mounting workability (a degraded fitting work efficiency).

In contrast to the above, in the shown embodiment, the recessed groove 57a is formed on the outside end side of cap main body 57 (that is, on the side being opposite to the side of electric motor 12), and the supporting portion 58 is engageably fitted and fixed into the recessed groove 57a from the outside. Hence, as discussed previously, when installing the seal cap 56 into the distal-end opening of communicating hole 35, the central position of supporting portion 58 is pushed toward the recessed groove 57a by the finger from the outside. There is no risk that the supporting portion 58 accidentally falls out of the cap main body 57 regardless of the magnitude of the force pushing the supporting portion. This facilitates the mounting work (the fitting work) of seal cap 56, thus improving the mounting workability (fitting work efficiency).

Also, the supporting portion 58 can be easily removed from the recessed groove 57a of cap main body 57 from the outside, making use of elastic deformation, and thus the ventilation filter 59 can be easily replaced.

The previously-discussed brush holders 23a, 23b of switching brushes 25a, 25b are located in the respective retaining holes 16c, 16d punched in the rigid plate 16, and fixed to the resin section 22. That is, these brush holders are located and fixed at the substantially center of the rigid plate 16 in the axial direction. Hence, the axial length of the electricity-feeding mechanism can be reduced as much as possible. As a result of this, the entire axial dimension of the device can be reduced or down-sized.

Furthermore, seal cap 56 is located radially inside of the inner and outer double electricity-feeding slip rings 26a, 26b. Even when wear debris (abrasion powder) arises from the sliding motion of electricity-feeding brushes 30a, 30b relative to respective slip rings 26a, 26b, there is a less tendency for the wear debris to be sprinkled or dusted over the seal cap 56. Hence, it is possible to suppress the ventilation filter 59 from being clogged with wear debris.

While the foregoing is a description of the preferred embodiments carried out the invention, it will be understood that the invention is not limited to the particular embodiments shown and described herein, but that various changes and modifications may be made. For instance, the structures of the cap main body 57, the supporting portion 58 and the like may be further modified.

Also, the cylindrical portion 34 may be eliminated from the cover member, and thus seal cap 56 may be installed directly into the communicating hole 35.

1. An internal-combustion engine valve timing control device adapted to vary a relative rotational phase of a camshaft to a crankshaft by energizing an electric motor comprising:
a cover member provided to cover at least a part of the electric motor;
slip rings provided at one of the electric motor and the cover member;
electricity-feeding brushes provided at the other of the electric motor and the cover member and having top ends kept in sliding-contact with the respective slip rings for electricity-feeding to the electric motor;
a clearance space defined between the electric motor and the cover member and configured such that sliding-contact parts of the slip rings with the electricity-feeding brushes face onto the clearance space;
a communicating hole formed in the cover member for communicating between the clearance space and an outside of the cover member; and
a ventilation plug press-fitted into the communicating hole from the outside of the cover member,
wherein the ventilation plug comprises:
a plug main body having a ventilation hole formed to penetrate through the plug main body in an axial direction and an outer circumferential part configured to be fitted to and retained in an outer opening edge of the communicating hole;
a fitting portion fitted into a recessed groove formed in an outside end face of the plug main body; and
a ventilation filter located on a bottom face of the recessed groove, onto which the ventilation hole faces, and retained and sandwiched between the plug main body and the fitting portion.

2. The internal-combustion engine valve timing control device as claimed in claim 1, wherein:
the communicating hole has a retaining protruded section and a retaining recessed section formed in an inner periphery of the communicating hole; and
the plug main body has an engaging groove and an engaging protrusion formed in an outer periphery of the plug main body, the engaging groove being configured to engage with the retaining protruded section, and the engaging protrusion being configured to engage with the retaining recessed section.

3. The internal-combustion engine valve timing control device as claimed in claim 2, wherein:
the fitting portion has a fitting protrusion formed in an outer periphery of the fitting portion; and
the recessed groove of the plug main body has a fitting groove formed in an inner periphery of the recessed groove on a side of the bottom face, the fitting groove being brought into fitted-engagement with the fitting protrusion.

4. The internal-combustion engine valve timing control device as claimed in claim 3, wherein:
the fitting protrusion of the fitting portion and the fitting groove of the plug main body are aligned with each other in a radial direction of the ventilation plug.

5. The internal-combustion engine valve timing control device as claimed in claim 1, wherein:
the ventilation filter is formed from a material that permits permeation of air between the clearance space and the outside of the cover member and that suppresses permeation of liquid and dust from the outside of the cover member to the clearance space.

6. The internal-combustion engine valve timing control device as claimed in claim 1, wherein:
a material of the plug main body is an elastically deformable synthetic resin material.

7. The internal-combustion engine valve timing control device as claimed in claim 1, wherein:
a material of the fitting portion is an elastically deformable synthetic resin material.

8. The internal-combustion engine valve timing control device as claimed in claim 1, wherein:
the plug main body has a flanged protrusion formed at a circumference of the plug main body; and
the flanged protrusion is configured to be brought into abutted-engagement with the outer opening edge of the communicating hole in the axial direction.

9. The internal-combustion engine valve timing control device as claimed in claim 8, wherein:
the cover member has a brush-retaining portion that retains the electricity-feeding brushes; and
the flanged protrusion of the ventilation plug has a partly-cut clearance groove for avoiding interference with an outer peripheral part of the brush-retaining portion.

10. The internal-combustion engine valve timing control device as claimed in claim 1, wherein:
the fitting portion has a ventilation hole formed to penetrate through the fitting portion in the axial direction, the ventilation hole of the fitting portion being configured to communicate with the ventilation hole of the plug main body.

11. The internal-combustion engine valve timing control device as claimed in claim 10, wherein:
a cross section of an outermost axial end of the ventilation hole of the fitting portion is dimensioned to be less in diameter than a cross section of an innermost axial end of the ventilation hole of the fitting portion facing the bottom face of the recessed groove of the plug main body.

12. An internal-combustion engine valve timing control device adapted to vary a relative rotational phase of a camshaft to a crankshaft by energizing an electric motor comprising:
a cover member provided to cover at least a part of the electric motor;
a communicating hole formed in the cover member for communicating between an inside and an outside of the cover member; and
a ventilation plug press-fitted into the communicating hole from the outside of the cover member,
wherein the ventilation plug comprises:
a plug main body having a ventilation hole formed to penetrate through the plug main body in an axial direction and an outer circumferential part configured to be fitted to and retained in an outer opening edge of the communicating hole;
a fitting portion fitted into a recessed groove formed in an outside end face of the plug main body; and
a ventilation filter retained in the recessed groove by the fitting portion.
